(19) United States
(12) Patent Application Publication
(10) Pub. No.: US 2009/0112737 A1
(43) Pub. Date: Apr. 30, 2009

(54) SUPPLY AND DEMAND MANAGEMENT OF INTELLIGENT ASSETS

(76) Inventors: Kenneth G. Owens, University City, MO (US); Candice M. Smith, St. Louis, MO (US); Leigh G. Malone, O'Fallon, MO (US)

Correspondence Address: HARNESS DICKEY & PIERCE, PLC, P.O. BOX 828, BLOOMFIELD HILLS, MI, 48303, US

(21) Appl. No.: 11/928,785

(22) Filed: Oct. 30, 2007

(51) Int. Cl. G06Q 10/00

(52) U.S. Cl. 705/28

(57) ABSTRACT

A computer-performed method of managing supply of and demand for a plurality of assets. A demand is received via a communications network. Based on the demand, one or more intelligent elements are queried via the network, each intelligent element being hosted by a corresponding asset. One or more replies to the querying are received from the intelligent element(s). Based on the replies, at least one of the asset(s) is selected in response to the demand. The method is performed in substantially real time.

### FIELD

The present disclosure relates generally to management of assets and, more particularly, to computer-implemented management of supply of and demand for assets.

### BACKGROUND

The statements in this section merely provide background information related to the present disclosure and may not constitute prior art.

In a large enterprise having a plurality of locations, it can be complicated and time consuming to track equipment, repair or maintenance parts, and other assets. When, for example, a part is needed in a maintenance action being performed in one location of the enterprise, it may not be clear as to how a spare part might be obtained with minimal expense and time. Ordering the needed part from a supplier can involve delay and expense, even though the part might in fact be easily obtainable from another location of the enterprise.

### SUMMARY

The present disclosure, in one implementation, is directed to a computer-performed method of managing supply of and demand for a plurality of assets. A demand is received via a communications network. Based on the demand, one or more intelligent elements are queried via the network, each intelligent element being hosted by a corresponding one of the assets. One or more replies to the querying are received from the intelligent element(s). Based on the replies, at least one of the asset(s) is selected in response to the demand. The method is performed in substantially real time.

In another implementation, the disclosure is directed to a system for managing supply of and demand for a plurality of assets. The system includes a communications network. Each asset hosts an intelligent element. At least one processor and memory are configured to communicate with the asset intelligent elements via the network. Each intelligent element is configured to maintain information pertaining to the hosting asset, and based on the information, to initiate a demand to the processor(s) and memory via the network.

In yet another implementation, the disclosure is directed to a computer-readable medium including computer-executable instructions for managing supply of and demand for a plurality of assets. The instructions are operable when executable by one or more processors to receive a demand via a communications network. The instructions are operable to, based on the demand, query one or more intelligent elements via the network, each intelligent element being hosted by a corresponding asset. The instructions are operable to receive one or more replies to the querying from the intelligent element(s); and based on the replie(s), select at least one of the asset(s) in response to the demand.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of a system for managing supply of and demand for a plurality of assets in accordance with one implementation of the disclosure;

FIG. 2 is a block diagram of an intelligent element in accordance with one implementation of the disclosure; and

FIG. 3 is a block diagram of a tool for managing supply of and demand for a plurality of assets in accordance with one implementation of the disclosure.

### DETAILED DESCRIPTION

The following description is merely exemplary in nature and is not intended to limit the present disclosure, application, or uses. In various implementations, the disclosure is directed to a system for managing supply of and demand for a plurality of assets. Such assets may include but are not limited to equipment, parts, furnishings, tools, etc. The system includes a software tool that communicates with intelligent elements hosted by the assets. An intelligent element of an asset makes it possible for the asset to store its own part information and maintenance history, and to identify itself in a networked environment. Thus, any asset capable of hosting an intelligent element as further described below could be managed using various implementations of the disclosure.

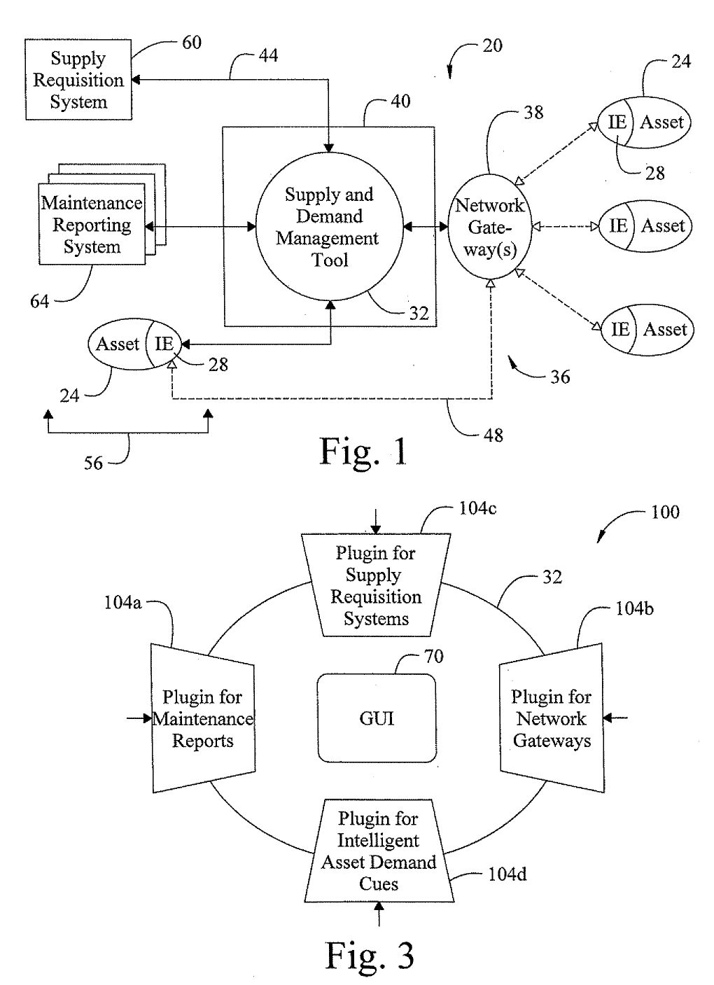

One implementation of a system for managing supply of and demand for a plurality of assets is indicated generally in FIG. 1 by reference number 20. The system 20 may be used, for example, by a large enterprise for management of requisitioning, maintenance, inventorying, and/or procurement of assets 24. The assets 24 may be distributed among a plurality of locations of the enterprise and may be of many different types.

The assets 24 are “intelligent”. For example, each asset 24 hosts an intelligent element 28 capable of retaining and transmitting information. Such information may include but is not limited to information pertaining to its hosting asset 24. Information may be transmitted wirelessly in the system 20, for example, between an asset's intelligent element 28 and a supply and demand management software tool 32. Wireless communication may be via a network indicated generally by reference number 36. The network 36 includes one or more gateways 38. It should be noted that where an enterprise in which the system 20 is used is very large, a plurality of network gateways 38 could be distributed over a range of locations.

The software tool 32 resides in one or more computers 40 having one or more processors and memory. Although a single computer 40 is shown in FIG. 1, it is understood in the art that many different numbers and configurations of computers, processors, and/or memory of various types could be used to provide the functionality described in the disclosure. It also should be noted that the disclosure may be implemented using at least some wired communication and is not limited to exclusively wireless connections. For example, in the system 20 wired connections 44 are indicated by solid lines and wireless connections 48 are indicated by dashed lines.

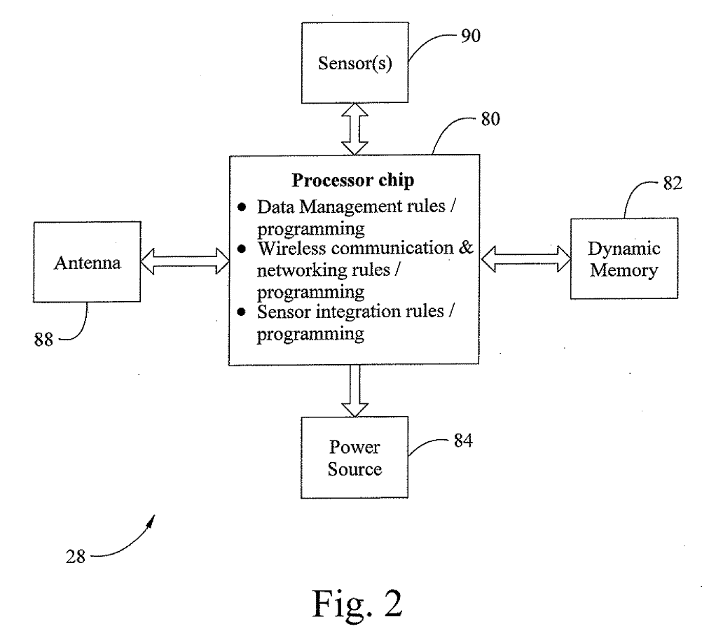

An exemplary intelligent element 28 is shown in FIG. 2. The element 28 includes a processor chip 80 and dynamic memory 82. The processor 80 is powered by a power source 84 and is operatively connected with a transmit/receive antenna 88. The processor 80 also communicates with one or more sensors 90. Sensor(s) 90 may sense variables such as temperature, vibration, humidity, energy usage, etc. The processor 80 is configured to execute rules and/or programming for data management, wireless communication and networking, and sensor integration.

The intelligent element 28 is configured to retain and wirelessly transmit identity, location and/or other information pertaining to its host asset 24. The element 28 may send and receive data and/or instructions pertaining to its host asset 24 across the network 36, through any gateway 38 within range. Intelligent elements 28 may include active radio frequency identification (RFID) tags such as motes. Exemplary motes may include but are not limited to Intel® Motes, available from Intel Corporation of Santa Clara, Calif., and/or Crossbow® Imote2 motes, available from Crossbow Technology, Inc. of San Jose, Calif.

It should be noted that intelligent elements are not limited to the foregoing configurations. Many different numbers, types and configurations of components are possible. As one example, an intelligent element could include more than one memory and/or more than one processor. Additionally or alternatively, one or more components of an intelligent element could be distributed with reference to its host asset. As one example, an antenna of an intelligent element could be positioned apart from a box holding other components of an intelligent element.

Intelligent elements 28 may communicate with one another to exchange data with one another. In such manner, assets 24 may self-organize into ad-hoc networks. Intelligent elements 28 can form wireless sensor networks. When a group of intelligent elements 28 are placed in proximity to one another, they are capable of wirelessly linking together to form a sensor network. The elements 28 may broadcast combined sensor data to various recipients. In some implementations, intelligent elements 28 in an ad-hoc network may broadcast to a single source, e.g., to an intelligent element 28 that is closer to a network gateway 38 than other intelligent elements 28 in the ad-hoc network. Thus, for example, if the number of gateways 38 in the system 20 is limited, a given gateway 38 can be located such that a single intelligent element 28 within communication range of the given gateway can provide access by other more remote intelligent elements 28 to that gateway.

Intelligent elements 28 can also communicate with one another to provide location information for a given intelligent element 28. Elements 28 can perform triangulation, for example, using signal timing. The timing can be used to obtain intersecting spatial arcs to locate an intelligent element. Additionally or alternatively, elements 28 can compare signal strength to obtain triangulation data for locating an element 28.

The software tool 32 can communicate with a plurality of demand sources 56. For example, a supply requisition system 60 may issue a requisition request to the tool 32, thereby cueing the tool 32 to locate an asset 24 to fulfill the requisition request. The tool 32 may be prompted by one or more maintenance reports from a maintenance reporting system 64 to locate one or more assets 24, e.g., for use as repair or replacement parts in a maintenance activity. Additionally or alternatively, an intelligent asset 24 may cue the tool 32 to take one or more actions. For example, information about the life expectancy of an asset 24 may be stored in memory of the intelligent element 28 hosted by the asset. When the asset 24 is approaching the end of its life expectancy, the intelligent element 28 may issue a requisition request to the tool 32 for a replacement for the host asset 24. In such manner, an intelligent asset 24 can request its own replacement.

Other or additional demand sources are possible. For example, inventory management could be performed using inventory-related information requested from intelligent assets 24 through the tool 32. Procurement of assets could also be performed using the tool 32. As an example, where the requisition system 60 requests an asset 24 that is determined to be unavailable, the tool 32 may initiate a request to a procurement system to procure such an asset.

A block diagram of the software tool 32 is indicated generally in FIG. 3 by reference number 100. The tool 32 includes a plurality of “plug-ins” 104, i.e., software subroutines configured to interface with demand sources 56 and with gateways 38. For example, a plug-in 104a is configured to interface with maintenance reporting system(s) 64, a plug-in 104b is configured to interface with network gateway(s) 38, a plug-in 104c is configured to interface with supply requisition system(s) 60, and a plug-in 104d is configured to interface with intelligent assets 24 issuing demand cues to the tool 32. The tool 32 also is configured to interface with a user, e.g., via a graphical user interface (GUI) 70.

Each plug-in 104 includes rules that determine how to interface with its associated demand source(s) and/or network gateway(s). Each plug-in 104 also includes instructions on how to find and retrieve specific data. When such data has been retrieved, it may be manipulated in accordance with data management rules configured into the tool 32. For example, the maintenance reporting system plug-in 104a is configured to query the maintenance reporting system(s) 64 for any asset requests generated by a maintenance action. Any such asset request information is brought into the tool 32. The tool 32, following applicable data management rules, queries intelligent assets 24 across the network 36 via gateways 38, e.g., for a suitable replacement asset 24. When the intelligent element 28 of an asset 24 receives such a query, it compares the query with its stored information. If the intelligent element 28 determines that its asset 24 is suitable, the intelligent element 28 responds to the query by identifying its asset 24 to the tool 32 and providing information as to location and/or condition of the asset. If more than one intelligent element 28 responds to the query, the tool 32 may compare the location of the demand with the location(s) of assets identified as suitable. The tool 32 may select an asset 24 that is easiest to transfer to the demand location.

As previously mentioned, the intelligent element 28 of an asset 24 may carry a service life expiration date of the asset 24 in memory. In some implementations, the tool 32 is configured to interrogate intelligent elements 28 for such expiration dates. When such a date approaches, the tool 32 may query the system 20 for a suitable replacement and may recommend, e.g., to a user of the system 20, an asset that would be easiest to transfer to the location of the expiring asset.

Intelligent elements 28 may initiate communication with the system 20 for various purposes. For example, an element 28 may use sensor information to monitor factors such as temperature that could influence the health and/or other operational aspects of the element 28 and/or its host asset 24. When, e.g., an element 28 senses a temperature outside a predefined range, the element can transmit an alert to a predefined destination in the system 20. Sensor information could also be used to monitor usage of assets 24. Other or additional types of data may be processed in an element 28. For example, an element 28 may maintain warranty information for its host asset 24. When a warranty expiration date approaches, the element 28 can transmit a notification to the system 20. It should be noted generally that many types of sensors and/or data processing could be implemented in an intelligent element, to address many kinds of asset-related issues.

A user of the tool 32 may use the GUI 70 to display and/or manipulate information obtained through the tool. For example, a user may review and approve the use of assets 24 selected by the tool 32. Additionally or alternatively, the user may select another asset 24, e.g., an asset nominated but not selected by the tool 32. The user may also use the GUI 70 to query the system 20, e.g., for available supplies. In various configurations, the system 20 allows the user to enter such queries directly into the system 20 without having to access the system through one of the demand source plug-ins 104. Thus a user can check inventory in real time, e.g., by entering part numbers to query the system 20 without having to enter a demand cue. Intelligent element data can be used in various ways to make forecasts for optimized procurement. Real-time inventory information from intelligent assets 24 can be used, e.g., to select a distribution center, so that replacement assets can be stocked in a center nearest the assets 24.

The foregoing tool can interface with a plurality of demand sources, communicate with intelligent assets distributed across a plurality of sites through network gateways, display real-time inventories of intelligent assets, and recommend suitable supplies to fill demands. Users can accept actions recommended by the system 20 or override such recommendations and propose other solutions.

When a requisition is initiated from any point in the lifecycle of an asset, the tool 32 can query the network 36 for the location of assets that meet specified criteria, make recommendations on which assets to utilize, and automate supply and demand management processes. The foregoing system can be used to 1) allow users to have instant access to real-time inventory levels and supply locations, 2) automate the process of identifying new demands, and 3) identify and optimize the routing of supplies to meet those demands.

The foregoing tool can be used to automate the process of identifying a demand, locating assets to fill that demand, and selecting an optimal unit (based, e.g., on demand and asset locations) to fill the demand. Assets can independently communicate across existing wireless networks through the deployment and integration of next generation sensors. Communication on the foregoing network can eliminate the need for redundant databases, can take advantage of existing wireless infrastructures, and can automate and optimize the process for asset acquisitions. Databases can be replaced by real-time surveying of assets, and receipt of realtime responses by assets, over a network.

Implementations of the foregoing apparatus and methods can provide a system that can identify, capture, and analyze supply and demand data to make “best course of action” recommendations with regard to the utilization of assets in the supply chain. An opportunity can be provided for asset managers and/or owners to form strategic partnerships. Implementing the foregoing system and method can increase visibility across partnering asset managers and/or owners, can reduce infrastructure costs, and can increase the availability of personnel to complete other tasks. Time efficiencies also can be realized in requisition, procurement, maintenance, and inventory management processes. Various implementations also can be used to optimize the process of identifying and selecting alternate assets and/or vendors.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A computer-performed method of managing supply of and demand for a plurality of assets, the method comprising:
receiving a demand via a communications network;
based on the demand, querying one or more intelligent elements via the network, each intelligent element hosted by a corresponding one of the assets;
receiving one or more replies to the querying from the one or more intelligent elements; and
based on the replies, selecting at least one of the one or more assets in response to the demand;
the method performed in substantially real time.

2. The method of claim 1, wherein the demand is received from an intelligent element hosted by one of the assets.

3. The method of claim 1, wherein the selecting is performed based on at least one of the following: an asset life expectancy, and an asset location.

4. The method of claim 1, further comprising initiating a requisition process to satisfy the demand.

5. The method of claim 1, further comprising substituting at least one other asset for the at least one selected asset, the substituting performed in response to user input.

6. A system for managing supply of and demand for a plurality of assets, the system comprising:
a communications network;
for each of the assets, an intelligent element hosted by the asset; and
at least one processor and memory configured to communicate with the asset intelligent elements via the network;
each intelligent element configured to:
maintain information pertaining to the hosting asset; and
based on the information, initiate a demand to the at least one processor and memory via the network.

7. The system of claim 6, wherein the demand is for at least one of the following: maintenance of the hosting asset, repair of the hosting asset, and replacement of the hosting asset.

8. The system of claim 6, wherein the at least one processor and memory are configured to:
based on the demand, query a plurality of the intelligent elements via the network;
evaluate information received from the plurality of intelligent elements; and
based on the evaluating, satisfy the demand.

9. The system of claim 6, wherein an intelligent element comprises an element processor, an element memory, and a transmit/receive antenna.

10. The system of claim 9, wherein an intelligent element comprises a mote.

11. The system of claim 9, wherein an intelligent element comprises one or more sensors in communication with the element processor.

12. The system of claim 6, wherein an intelligent element is further configured to provide at least some of the information pertaining to the hosting asset to a user upon receiving a query from the user via the network.

13. The system of claim 12, wherein the user query includes an identifier of the hosting asset.

14. The system of claim 6, wherein the information comprises at least one of the following: identification of the asset, maintenance history of the asset, part information for the asset, and a current condition pertaining to the asset.

15. The system of claim 6, wherein the intelligent elements are configured to form an ad-hoc network.

16. A computer-readable medium including computer-executable instructions for managing supply of and demand for a plurality of assets, the instructions operable when executable by one or more processors to:
receive a demand via a communications network;
based on the demand, query one or more intelligent elements via the network, each intelligent element hosted by a corresponding one of the assets;
receive one or more replies to the querying from the one or more intelligent elements; and
based on the replies, select at least one of the one or more assets in response to the demand.

17. The computer-readable medium of claim 16, the instructions further operable to receive the demand from an intelligent element hosted by one of the assets.

18. The computer-readable medium of claim 16, the instructions further operable to select at least one of the one or more assets based on at least one of the following: an asset life expectancy, and an asset location.

19. The computer-readable medium of claim 16, the instructions further operable to initiate a requisition of the one or more selected assets to satisfy the demand.

20. The computer-readable medium of claim 16, the instructions further operable to, in response to input from a user, substitute at least one other asset for the at least one selected asset.
